(19) United States
(12) Patent Application Publication
(10) Pub. No.: US 2023/0146049 A1
(43) Pub. Date: May 11, 2023

(54) USAGE CONDITION PROPOSAL SYSTEM, USAGE CONDITION PROPOSAL METHOD, AND NON-TRANSITORY STORAGE MEDIUM

(71) Applicant: TOYOTA JIDOSHA KABUSHIKI KAISHA, Toyota-shi (JP)

(72) Inventors: Eisuke AOKI, Toyota-shi (JP); Takahiro TAKEDA, Toyota-shi (JP); Tadashi ODASHIMA, Toyota-shi (JP)

(73) Assignee: TOYOTA JIDOSHA KABUSHIKI KAISHA, Toyota-shi (JP)

(21) Appl. No.: 17/886,649

(22) Filed: Aug. 12, 2022

(30) Foreign Application Priority Data
Nov. 11, 2021 (JP) 2021-184113

(51) Int. Cl. A63B 21/00; A63B 23/04

(52) U.S. Cl. CPC A63B 21/4034; A63B 23/0476

(57) ABSTRACT

A usage condition proposal system includes a storage medium that stores a reference DB having a plurality of pieces of causal relationship information that includes training information and variation range information, the training information including physical information for a user and usage condition information for a training machine, variation range information indicating a variation range of a joint angle of at least one joint of the user when the user trains using the training machine based on the usage condition information. A processor is configured to extract, with reference to the reference DB, based on the physical information and the specified variation range information, the causal relationship information of which the variation range information indicates the variation range satisfying a predetermined relationship with the specified variation range.

### CROSS-REFERENCE TO RELATED APPLICATION

This application claims priority to Japanese Patent Application No. 2021-184113 filed on Nov. 11, 2021, incorporated herein by reference in its entirety.

### BACKGROUND

### 1. Technical Field

The present disclosure relates to a usage condition proposal system, a usage condition proposal method, and a non-transitory storage medium.

### 2. Description of Related Art

A foot pedaling exercise machine for performing a foot pedaling exercise in a sitting position is known (for example, Japanese Unexamined Patent Application Publication No. 10-094577 (JP 10-094577 A)).

### SUMMARY

In the foot pedaling exercise, the hip joint, knee joint, and ankle joint of a user are mainly moved frequently. However, the actual situation is that movable ranges of the hip joint, knee joint, and ankle joint differs for each user.

Here, the “movable range of each joint” means a range of a joint angle within which the joint can be moved without being strained or a range of a joint angle within which the joint can be moved without pain. On the other hand, a “variation range of each joint” means the range within which the joint angle varies during the actual foot pedaling exercise.

Therefore, it is desirable to adjust usage conditions of the foot pedaling exercise machine such that the variation range of each joint is within the movable range of the corresponding joint, when the user uses the foot pedaling exercise machine.

However, it is very difficult to predict how the variation range of each joint changes, that is, how the maximum value and the minimum value of the variation range change, depending on how the usage conditions of the foot pedaling exercise machine are specifically adjusted. Accordingly, when the user uses the foot pedaling exercise machine, the user has to go through trial and error, such as, the user executes the foot pedaling exercise after changing the usage conditions of the foot pedaling exercise machine at random and the user test different usage conditions when any of the joints is painful. As a consequence, it may be difficult to start the foot pedaling exercise due to the time taken to adjust the usage conditions of the foot pedaling exercise machine, or it may be likely to cause an aversion to the foot pedaling exercise from some pain in the adjustment.

Aspects of the present disclosure provide a technique for setting a variation range of a joint angle as desired when a training machine is used for training.

A first aspect of the present disclosure relates to a usage condition proposal system. The usage condition proposal system includes a storage medium and a processor. The storage medium stores a reference database (DB) having a plurality of pieces of causal relationship information that includes training information and variation range information. The training information includes physical information for a user and usage condition information for a training machine, and the variation range information indicates a variation range of a joint angle of at least one joint of the user when the user trains using the training machine based on the usage condition information. The processor is configured to receive an input of the physical information for the user, receive an input of specified variation range information indicating a specified variation range that is a variation range specified for the joint angle of the at least one joint of the user, extract, with reference to the reference DB, based on the physical information and the specified variation range information, the causal relationship information of which the variation range information indicates the variation range satisfying a predetermined relationship with the specified variation range, and output the usage condition information in the extracted causal relationship information.

A second aspect of the present disclosure relates to a usage condition proposal method that is executed by a CPU of a computer. The CPU of the computer is configured to refer to a reference DB having a plurality of pieces of causal relationship information that includes training information and variation range information. The training information includes physical information for a user and usage condition information for a training machine, and the variation range information indicates a variation range of a joint angle of at least one joint of the user when the user trains using the training machine based on the usage condition information. The usage condition proposal method includes receiving an input of the physical information for the user, receiving an input of specified variation range information indicating a specified variation range that is a variation range specified for the joint angle of the at least one joint of the user, extracting, with reference to the reference DB, based on the physical information and the specified variation range information, the causal relationship information of which the variation range information indicates the variation range satisfying a predetermined relationship with the specified variation range, and outputting the usage condition information in the extracted causal relationship information.

According to the present disclosure, it is possible to set the variation range of the joint angle of the at least one joint as desired when the training machine is used for training.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a side view of a foot pedaling exercise machine;

FIG. 2 is a side view of the foot pedaling exercise machine;

FIG. 3 is a schematic side view of the foot pedaling exercise machine;

FIG. 4 is a functional block diagram of a usage condition proposal device;

FIG. 5A is a diagram showing a part of a data structure of a reference database (DB);

FIG. 5B is a diagram showing the other part of a data structure of the reference database (DB);

FIG. 6 is a diagram showing an example of an input screen;

FIG. 7 is a diagram showing an example of an output screen; and

FIG. 8 is a control flow of the usage condition proposal device.

### DETAILED DESCRIPTION OF EMBODIMENTS

Hereinafter, the present disclosure will be described through embodiments, but the disclosure according to the claims is not limited to the following embodiments. Moreover, not all of the configurations described in the embodiments are indispensable as means for solving the problem. In order to clarify the description, the following description and drawings are omitted and simplified as appropriate. In drawings, the same elements are designated by the same reference numerals, and repeated descriptions thereof are omitted as necessary.

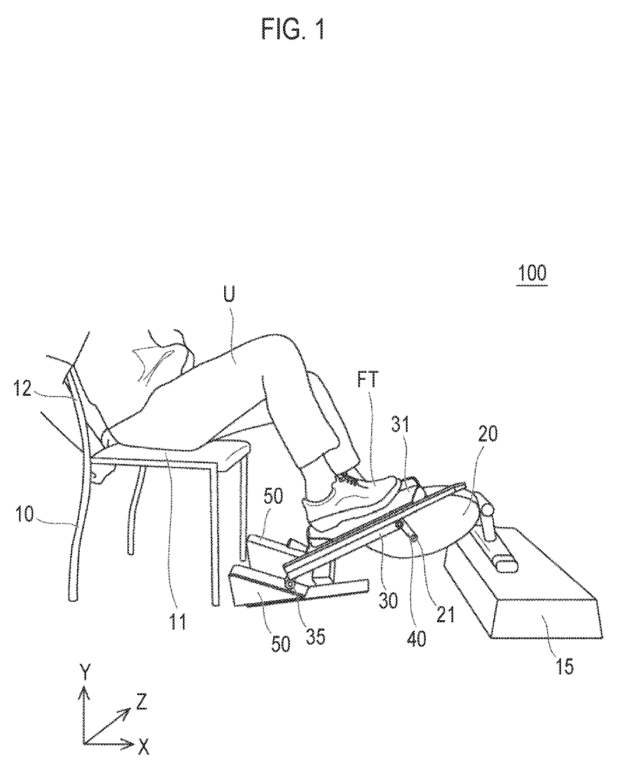

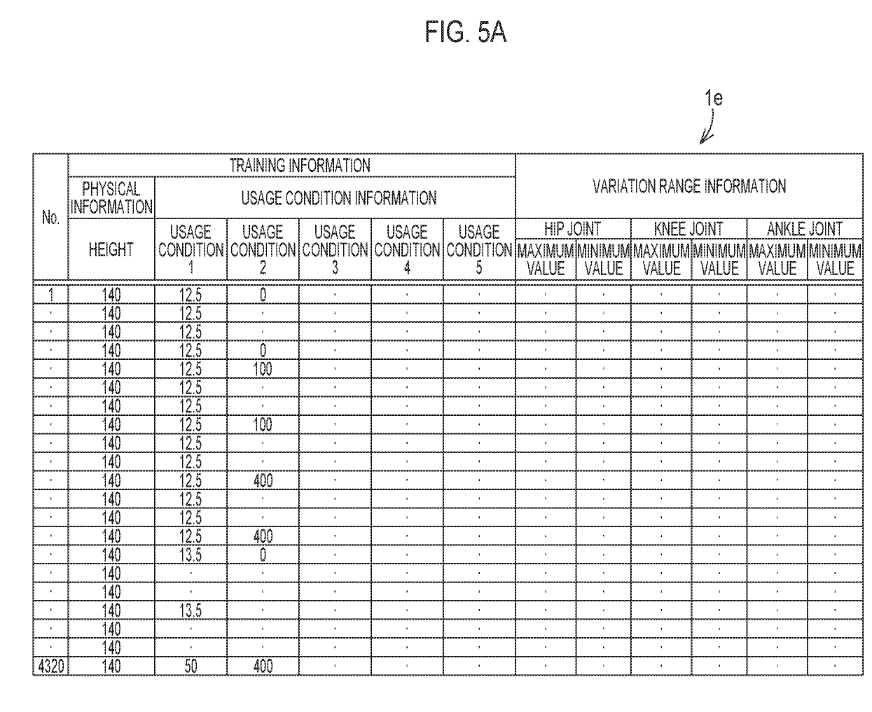

First, the foot pedaling exercise machine will be described with reference to FIGS. 1 to 3, and the usage condition proposal device will be described with reference to FIGS. 4 to 8.

### Foot Pedaling Exercise Machine

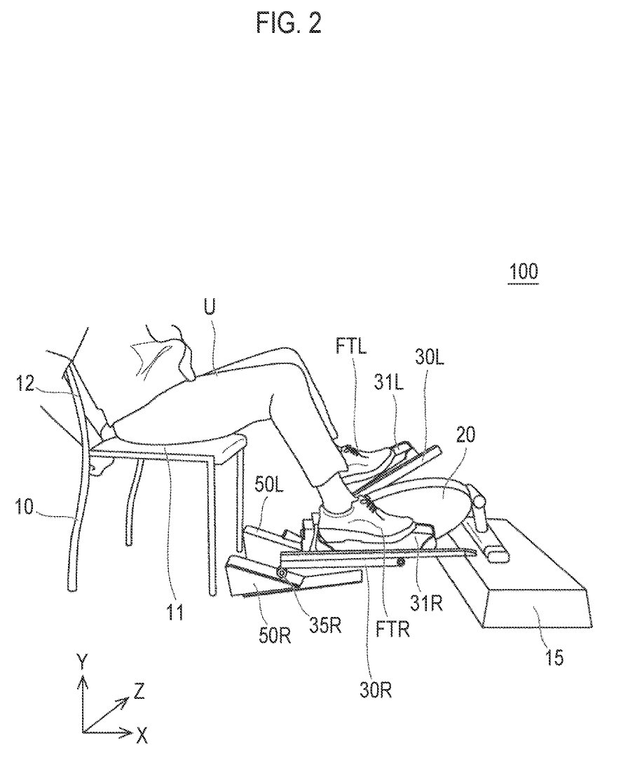

FIGS. 1 and 2 show a foot pedaling exercise machine 100. The foot pedaling exercise machine 100 is an exercise machine with which a user U performs a foot pedaling exercise in a sitting position. The foot pedaling exercise machine 100 is a specific example of a training machine. In addition to the foot pedaling exercise machine 100, the training machine may be stepping exercise machine with which the user U performs a stepping exercise in a sitting position or another exercise machine adapted for bending and stretching of an upper limb joint or a lower limb joint.

FIGS. 1 and 2 are views of the foot pedaling exercise machine 100 as viewed from the side. In the following description, in order to clarify the description, an XYZ three-dimensional Cartesian coordinate system will be used. Specifically, the +X direction is the forward direction, the -X direction is the rearward direction, the +Y direction is the upward direction, the -Y direction is the downward direction, the +Z direction is the left direction, and the -Z direction is the right direction. A front-rear direction, a right-left direction, and a up-down direction are directions with respect to a standard line-of-sight direction when the user U is exercising.

The foot pedaling exercise machine 100 allows variation ranges of the hip joint, the knee joint, and the ankle joint to be adjusted at the time of doing the foot pedaling exercise. In the following description, a rotation direction around a Z axis of the ankle joint is defined as a dorsi-plantar flexion direction, and the angle is defined as a dorsi-plantar flexion angle. The dorsi-plantar flexion direction includes a plantar flexion direction as a direction in which the toes are directed downward and a dorsiflexion direction as a direction in which the toes are directed upward.

As shown in FIG. 1, the foot pedaling exercise machine 100 has a main body 20, a link 30, a crank 40, and inclined bases 50. A chair 10 is provided behind the foot pedaling exercise machine 100. The user U performs a foot pedaling exercise while the user U is sitting on the chair 10. The user U performs the foot pedaling exercise in a sitting position. The chair 10 may be provided integrally with the foot pedaling exercise machine 100, or may be provided as a separate body. For example, the chair 10 may be a chair in a facility or home where the user U is located. That is, the user U or an assistant may install the chair 10 behind the foot pedaling exercise machine 100. The chair 10 may be a wheelchair that the user U usually uses.

The chair 10 includes a seat portion 11 as a seating portion and a backrest portion 12. With the user U sitting on the seat portion 11, the backrest portion 12 supports the back of the user U. That is, the user U can perform the foot pedaling exercise while the user U is leaning against the backrest portion 12. Further, the chair 10 is replaceable or adjustable to suit the user U. For example, for the user U who performs training with a higher load, a chair 10 without the backrest portion 12 can be used. Alternatively, the backrest portion 12 may have a reclining mechanism. Then, the angle of the backrest portion 12 may be adjusted by the reclining mechanism.

In the foot pedaling exercise machine 100, components attached to the main body 20 are horizontally symmetrical. In FIG. 2, in order to distinguish right and left components, R is attached to right components of the main body 20 and L is attached to left components thereof. For example, in FIG. 2, the right inclined base 50 is shown as an inclined base 50R and the left inclined base 50 is shown as an inclined base 50L. Similarly, the link 30 and the pedal 31 on the right are a link 30R and a pedal 31R, respectively, the link 30 and the pedal 31 on the left are a link 30L and a pedal 31L, respectively. Similarly, a foot FT on the right is referred to as a right foot FTR and a foot FT on the left is referred to as a left foot FTL. In the following description, when the right and left components are not distinguished, R and L are omitted.

The main body 20 holds the crank 40 such that the crank 40 be rotatable. For example, the main body 20 is provided with a rotating shaft 21. The crank 40 is connected to the rotating shaft 21. The crank 40 extends in a direction orthogonal to a longitudinal direction of the rotating shaft 21. The crank 40 rotates around a rotating shaft 21. The main body 20 may have a load resistor that gives a load to the rotational movement of the crank 40. The main body 20 may have a gear or the like for making the load variable.

The main body 20 is disposed on an installation base 15. The installation base 15 is disposed on a floor surface. For example, the front portion of the main body 20 is disposed on the installation base 15, and the rear portion is disposed on the floor surface. The installation base 15 can be omitted.

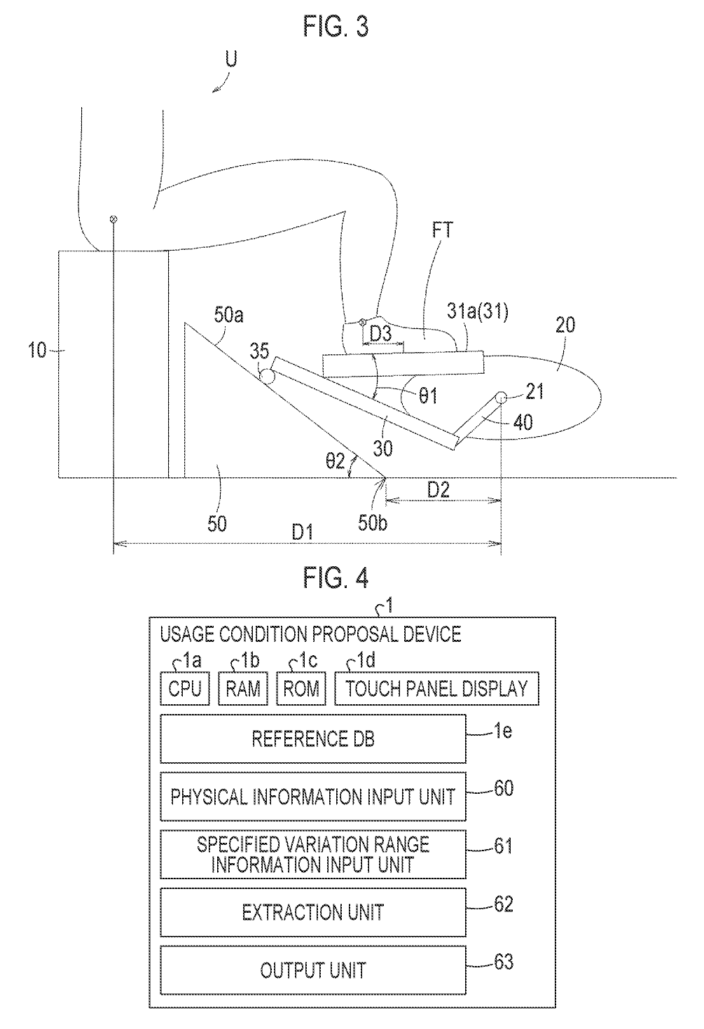

The distance between the main body 20 and the chair 10 in the front-rear direction may be changed depending on the user U. For example, the user U can dispose the chair 10 close to the main body 20. Thereby, the user U performs the foot pedaling exercise with the knee joint or the like relatively flexed. Alternatively, the user U can dispose the chair 10 away from the main body 20. Thereby, the user U performs the foot pedaling exercise with the knee joint or the like relatively extended. By changing the distance between the main body 20 and the chair 10 in the X direction in this way, the posture of the user U during the foot pedaling exercise changes. Therefore, it is possible to adjust the variation range of each joint during the foot pedaling exercise of the user U. The distance between the main body 20 and the chair 10 in the front-rear direction is an example of the usage conditions of the foot pedaling exercise machine 100. Hereinafter, for convenience of description, in FIG. 3, the distance in the horizontal direction between the hip joint of the user U and a rotating shaft 21 of the main body 20 is defined as a distance D1. The distance D1 is a specific example of static usage conditions of the foot pedaling exercise machine 100. Here, the “static usage condition” means a usage condition that can be specified with the crank 40 stopped. In contrast, for example, the rotational speed of the crank 40 is a dynamic usage condition of the foot pedaling exercise machine 100. When the distance D1 is set to be large, the variation range of the hip joint and the knee joint can be shifted to the extension side, and the variation range of the ankle joint can be shifted to the plantar flexion side. When the distance D1 is set to be small, the variation range of the hip joint and the knee joint can be shifted to the flexion side, and the variation range of the ankle joint can be shifted to the dorsiflexion side.

The link 30 has the pedal 31 and a sliding wheel 35. The crank 40 is connected to the front end of the link 30, and the sliding wheel 35 is connected to the rear end thereof. The crank 40 and the link 30 are rotatably connected. For example, the link 30 is attached to the crank 40 via a bearing or the like. The pedal 31 is attached to the link 30 in the middle. The pedal 31 is a step (footrest) on which the user U puts the foot FT. The seated user U puts the foot FT on a foot rest surface 31a of the pedal 31. As shown in FIG. 3, in the side view of the foot pedaling exercise machine 100, an angle θ1 between the longitudinal direction of the link 30 and the foot rest surface 31a of the pedal 31 may be adjustable. The angle θ1 may be adjustable, for example, between 0 and 45 degrees. When the angle θ1 is set to be large, the variation range of the ankle joint can be shifted to the dorsiflexion side. When the angle θ1 is set to be small, the variation range of the ankle joint can be shifted to the plantar flexion side. The angle θ1 is a specific example of static usage conditions of the foot pedaling exercise machine 100.

The sliding wheel 35 is attached to the link 30 via a rotating shaft (axle). That is, the link 30 rotatably holds the sliding wheel 35. The sliding wheel 35 is a sliding member that slides on the inclined surface of the inclined base 50.

The user U puts the foot FT on the pedal 31 and performs the foot pedaling exercise. That is, the user U moves the knee joint, the hip joint, and the ankle joint, to step on the foot FT. Thereby, the crank 40 rotates around the rotating shaft 21. Further, the angle between the link 30 and the crank 40 changes with the rotation of the crank 40. That is, the relative angle of the link 30 with respect to the crank 40 changes with the rotation angle of the crank 40 (hereinafter, also referred to as “crank angle”). The crank angle typically means the angle formed between the crank 40 and a reference line extending forward from the rotating shaft 21. Further, the sliding wheel 35 moves in the front-rear direction in a state of being in contact with an inclined surface 50a of the inclined base 50. Thereby, the crank 40 and the link 30 rotate such that the pedal 31 moves along an elliptical trajectory in response to the foot pedaling exercise. That is, the user U mainly applies a load to a plurality of muscles constituting the lower leg of the user U by moving a foot FT mounted on the pedal 31 along an elliptical trajectory defined by the foot pedaling exercise machine 100.

The pedal 31, the sliding wheel 35, the link 30, the crank 40, and the inclined base 50 are provided for the right and left feet FT of the user U, respectively. That is, the pedals 31, sliding wheels 35, links 30, cranks 40, and inclined bases 50 are provided on the right and left sides of the main body 20, respectively. The pedal 31R, the sliding wheel 35R, the link 30R, the inclined base 50R, and the like provided on the right side of the main body 20 are related to the right foot FTR of the user U. The pedal 31L, the link 30L, and the inclined base 50L provided on the left side of the main body 20 are related to the left foot FTL of the user U.

The cranks 40 are attached to the rotating shaft 21 of the main body 20 so as to be in opposite phase with respect to the right and left feet FT. That is, the rotation angles of the crank 40 for the left foot and the crank 40 for the right foot are offset by 180°. The user U alternately expands and contracts the left leg and the right leg to perform the foot pedaling exercise.

The sliding wheel 35 is attached to the rear end of the link 30. The sliding wheel 35 has a wheel that slides on the inclined surface 50a of the inclined base 50. The inclined base 50 has the inclined surface 50a that becomes higher toward the rear. The sliding wheel 35 reciprocates in the X direction (front-rear direction) with the rotational movement of the link 30. As shown in FIG. 1, while the user U is executing the foot pedaling exercise in the direction of extending the right leg and bending the left leg, the right sliding wheel 35 moves forward and the left sliding wheel 35 moves backward. As shown in FIG. 2, while the user U is executing the foot pedaling exercise in the direction of extending the left leg and bending the right leg, the left sliding wheel 35 moves forward and the right sliding wheel 35 moves backward.

The height of the sliding wheel 35 changes along the inclined surface 50a of the inclined base 50. The height of the inclined surface 50a of the inclined base 50 becomes higher toward the rear. That is, the inclined base 50 is an uphill for the sliding wheel 35 moving backward. Therefore, while the sliding wheel 35 is moving backward, the sliding wheel 35 is gradually raised. In contrast, while the sliding wheel 35 is moving forward, the sliding wheel 35 is gradually lowered. The angle of the link 30 is defined according to the height of the sliding wheel 35.

Here, the angle of the pedal 31 provided on the link 30 is limited by the height of the sliding wheel 35. That is, when the sliding wheel 35 becomes raised, the pedal 31 rotates in the plantar flexion direction. When the sliding wheel 35 becomes lowered, the pedal 31 rotates in the dorsiflexion direction. Therefore, the variation range of the dorsi-plantar flexion angle of the ankle joint can be adjusted with an inclination angle of the inclined surface 50a of the inclined base 50. As shown in FIG. 3, an inclination angle θ2 of the inclined surface 50a of the inclined base 50 with respect to the horizontal is a specific example of static usage conditions of the foot pedaling exercise machine 100. When the inclination angle θ2 is set to be large, the variation range of the ankle joint shifts to the plantar flexion side. When the inclination angle θ2 is set to be small, the variation range of the ankle joint shifts to the dorsiflexion side.

A distance D2 in the horizontal direction between a front end portion 50b of the inclined base 50 and the rotating shaft 21 is a specific example of static usage conditions of the foot pedaling exercise machine 100. When the distance D2 is increased, the variation range of the ankle joint shifts to the dorsiflexion side. When the distance D2 is reduced, the variation range of the ankle joint shifts to the plantar flexion side.

The use of the inclined base 50 is optional, and the foot pedaling exercise may be performed without using the inclined base 50. In this case, the presence or absence of the inclined base 50 is one of specific examples of the static usage conditions of the foot pedaling exercise machine 100.

Continuously referring to FIG. 3, the foot rest surface 31a of the pedal 31 is longer than the total length of the foot FT. Therefore, the user U can put the foot FT near the tip (close to the toes) of the foot rest surface 31a of the pedal 31, or can put the foot FT near the rear end (close to the heel) of the foot rest surface 31a of the pedal 31. The distance from the center of the foot rest surface 31a in the longitudinal direction to the ankle joint is defined as a distance D3. The distance D3 is a specific example of static usage conditions of the foot pedaling exercise machine 100. The distance D3 becomes smaller when the foot FT is put near the tip of the foot rest surface 31a of the pedal 31, and becomes larger when the foot FT is put near the rear end of the foot rest surface 31a of the pedal 31.

The user U performs the foot pedaling exercise with the foot pedaling exercise machine 100 mainly for training the lower limbs. That is, the user U can apply a load to the muscles of the lower limbs and the trunk by performing the foot pedaling exercise. Examples of the muscles that can be trained with the foot pedaling exercise machine 100 include the rectus abdominis muscle, the gluteus maximus muscle, the external obturator muscle, the erector spinae muscle, the vastus medialis muscle, the vastus intermedius muscle, the rectus femoris muscle, gastrocnemius muscle, the adductor brevis muscle, the biceps femoris muscle, the middle gluteal muscle, the plantaris muscle, the flathead muscle, the small gluteal muscle, the patellar muscle, the anterior tibial muscle, the iliacus muscle, the large lumbar muscle, and the thigh square muscle.

In the present embodiment, the distance D1, the distance D2, the distance D3, the angle θ1, and the inclination angle θ2 shown in FIG. 3 are taken up as specific examples of the static usage conditions of the foot pedaling exercise machine 100. However, the present embodiment is not limited to the mentioned above, and the height of the seat portion 11 of the chair 10, the link length of the link 30, and the diameter of the sliding wheel 35 may also be static usage conditions of the foot pedaling exercise machine 100 when they can be adjusted.

As described above, it is possible to adjust the variation ranges of the hip joint, knee joint, and ankle joint by changing a plurality of static usage conditions of the foot pedaling exercise machine 100. Here, “adjusting the variation range” means any of adjusting the maximum value of the variation range, adjusting the minimum value of the variation range, and adjusting the maximum value and the minimum value of the variation range.

Therefore, for example, when the variation ranges of the hip joint, knee joint, and ankle joint are adjusted such that the variation ranges of the hip joint, knee joint, and ankle joint match the movable ranges of the hip joint, knee joint, and ankle joint of the user U, the user U may be able to perform the foot pedaling exercise without difficulty.

### Usage Condition Proposal Device

Subsequently, a usage condition proposal device 1 will be described with reference to FIGS. 4 to 8. The usage condition proposal device 1 is a specific example of the usage condition proposal system. The usage condition proposal device 1 proposes, to the user U and his or her assistant, the static usage conditions of the foot pedaling exercise machine 100 for achieving the variation range of each joint of the user U, by simply inputting the height of the user U and specifying the variation range of the user U. With the usage condition proposal device 1, there is no need to make trial and error such that the variation ranges of the hip joint, knee joint, and ankle joint matches the movable ranges of the hip joint, knee joint, and ankle joint of the user U, and thus the foot pedaling exercise can be started promptly under the conditions suitable for the user U, and the pain associated with trial and error can be separated.

FIG. 4 shows a functional block diagram of the usage condition proposal device 1. As shown in FIG. 4, the usage condition proposal device 1 includes a central processing unit (CPU) 1a, a random access memory 1b that is free to read and write, and a read-only memory (ROM) 1c that is read. The usage condition proposal device 1 further includes a touch panel display 1d. The usage condition proposal device 1 further includes a reference DB 1e. The reference DB 1e is typically a database stored in an HDD (not shown). However, instead of the usage condition proposal device 1 including the reference DB 1e, the usage condition proposal device 1 may access the reference DB of the external server via the Internet.

Then, the CPU 1a reads out and executes a control program stored in the ROM 1c such that the control program causes hardware such as the CPU 1a to function as a physical information input unit 60, a specified variation range information input unit 61, an extraction unit 62, and an output unit 63.

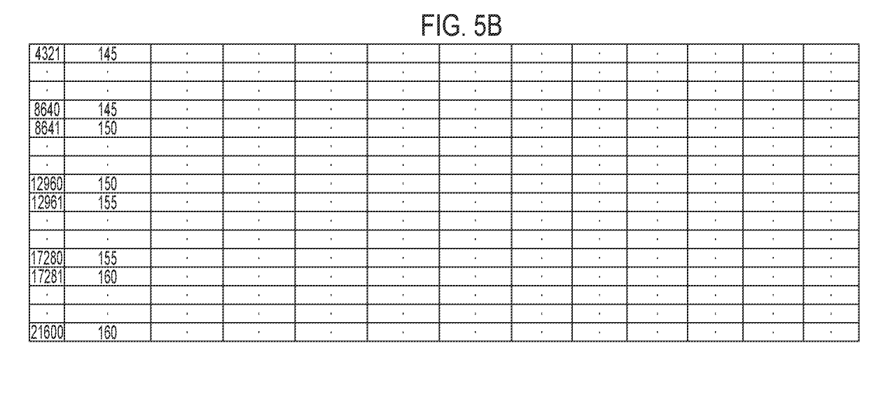

The reference DB 1e is a database including a plurality of pieces of causal relationship information. FIGS. 5A and 5B show a data structure of the reference DB 1e. As shown in FIGS. 5A and 5B, in the present embodiment, the reference DB 1e contains 21,600 pieces of causal relationship information. That is, the reference DB 1e includes causal relationship information No. 1 to causal relationship information No. 21,600 (FIG. 5A shows causal relationship information No. 1 to No. 4320, and FIG. 5B shows causal relationship information No. 4321 to No. 21,600).

Each piece of causal relationship information includes training information and variation range information corresponding to the training information.

The training information includes physical information for the user U and usage condition information for the foot pedaling exercise machine 100.

The physical information for the user U is information indicating the size of the body of the user U, and is information indicating at least one or more of the height, thigh length, lower leg length, and height of the ankle joint from the bottom of the foot (hereinafter, also simply referred to as “ankle joint height) of the user U. In the present embodiment, the physical information for the user U indicates the height of the user U. However, alternatively, the physical information for the user U may be any one of the thigh length, the lower leg length, and the ankle joint height. In general, there is a positive correlation between the height and thigh length, lower leg length, and ankle joint height, and thus it is considered that the other three can be derived from any one of the dimensions.

The usage condition information indicates a plurality of static usage conditions that is adjustable when the foot pedaling exercise machine 100 is used. In the example of FIGS. 5A and 5B, the usage conditions include a usage condition 1, a usage condition 2, a usage condition 3, a usage condition 4, and a usage condition 5.
The usage condition 1 corresponds to the inclination angle θ2 in FIG. 3.
The usage condition 2 corresponds to the distance D2 in FIG. 3.
The usage condition 3 corresponds to the distance D3 in FIG. 3.
The usage condition 4 corresponds to the distance D1 in FIG. 3.
The usage condition 5 corresponds to the inclination angle θ1 in FIG. 3.

The usage condition information may indicate just one usage condition instead of indicating five usage conditions, or may indicate six or more usage conditions.

The variation range information indicates the variation ranges of the joint angles of the hip joint, knee joint, and ankle joint of the user U when the user U, who has the corresponding physical information, performs the foot pedaling exercise using the foot pedaling exercise machine 100 based on the corresponding usage condition information. The joint angles are all joint angles around a pitch axis.

That is, when the user U, who has the corresponding physical information, performs the foot pedaling exercise using the foot pedaling exercise machine 100 based on the corresponding usage condition information, the maximum value and the minimum value of the variation range of the joint angle of the hip joint are as shown in FIGS. 5A and 5B. The same applies to the knee joint and the ankle joint. However, in FIGS. 5A and 5B, the values are abbreviated as “·”.

The pieces of causal relationship information are different from each other in at least one of the physical information and the usage condition information. Causal relationship information No. 1 to No. 4,320 are causal relationship information about the user U who is 140 cm tall, and covers all combinations of dimensions indicated by the five usage conditions as much as possible. In the present embodiment, the inclination angle θ2 (usage condition 1) is divided into four kinds, the distance D2 (usage condition 2) is divided into in five kinds, the distance D3 (usage condition 3) is divided into six kinds, the distance D1 (usage condition 4) is divided into nine kinds, and the angle θ1 (usage condition 5) is divided into four kinds. Therefore, 4 × 5 × 6 × 9 × 4 = 4,320 kinds of causal relationship information are prepared as causal relationship information regarding the user U having a height of 140 cm. The height of the user U is divided into five kinds from 140 cm to 160 cm in 5 cm increments. Therefore, there are 4320 × 5 = 21,600 kinds of causal relationship information possessed by the reference DB 1e.

The 21,600 kinds of causal relationship information possessed by the reference DB 1e can be generated by, for example, a simulator using a human computer model. That is, the simulator generates a human body model and an exercise machine model based on training information, and records the maximum value and the minimum value of the variation range of the joint angle of each joint with the change of the crank angle. Alternatively, the causal relationship information may be generated based on measured values obtained by asking a plurality of users U who are 140 cm, 145 cm, 150 cm, 155 cm, and 160 cm in height to actually perform the foot pedaling exercise with the foot pedaling exercise machine 100 according to their own usage condition information, and measuring the maximum value and the minimum value of the variation range of the joint angle of each joint with the change of the crank angle at that time.

The physical information input unit 60 receives an input of physical information for the user U who is to use the foot pedaling exercise machine 100 from now on. In the present embodiment, the physical information indicates the height as described above.

The specified variation range information input unit 61 receives an input of specified variation range information indicating a specified variation range that is a variation range specified for the joint angle of at least one joint of the user. In the present embodiment, the specified variation range information indicates a specified variation range that is specified for the variation range of at least one joint angle of the hip joint, knee joint, and ankle joint of the user. The variation range is typically specified by the maximum value and the minimum value thereof. However, the variation range may be specified simply by the maximum value or simply by the minimum value. For example, when there is pain on the knee joint on the extension side of the joint angle thereof but not on the flexion side, the variation range is to be specified simply by the maximum value. The specifying entity is typically the user U himself or herself or an assistant.

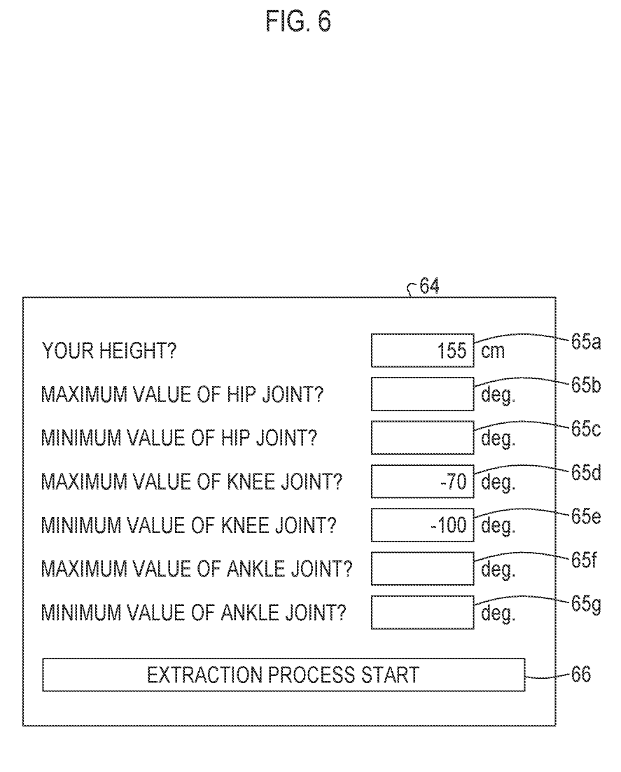

FIG. 6 illustrates an input screen of physical information and specified variation range information displayed on a display screen 64 of the touch panel display 1d. The user U himself or herself or the assistant inputs the height of the user into a text box 65a displayed on the display screen 64. Similarly, the user U himself or herself or the assistant inputs the maximum value and the minimum value of the desired variation range of the joint angle of the hip joint into a text box 65b and a text box 65c, respectively. Similarly, the user U himself or herself or the assistant inputs the maximum value and the minimum value of the desired variation range of the joint angle of the knee joint into a text box 65d and a text box 65e, respectively. Similarly, the user U himself or herself or the assistant inputs the maximum value and the minimum value of the desired variation range of the joint angle of the ankle joint into a text box 65f and a text box 65g, respectively.

The user U himself or herself or the assistant does not have to input everything from the text box 65b to the text box 65g, and for example, may input a desired value just into the text box 65b when he or she wants to specify merely the maximum value of the variation range of the joint angle of the hip joint. In the example of FIG. 6, the case where merely the maximum value and the minimum value of the variation range of the joint angle of the knee joint are specified is illustrated, and in this case, desired values are input just to the text box 65d and the text box 65e corresponding to the maximum value and the minimum value of the variation range of the joint angle of the knee joint. Alternatively, the maximum value and the minimum value of the variation ranges of the joint angles of the knee joint and the ankle joint may be specified, and the maximum value and the minimum value of the variation range of the joint angle of the ankle joint and the maximum value of the variation range of the joint angle of the knee joint may be specified.

When a button of the extraction process start 66 shown in FIG. 6 is pressed, the extraction unit 62 refers to the reference DB 1e, and extracts causal relationship information indicating that the variation range indicated by the variation range information in the reference DB 1e satisfies a predetermined relationship with the specified variation range, based on the physical information and the specified variation range information.

In the example of FIG. 6, the height of the user U is input to be 155 cm, the maximum value of the variation range of the joint angle of the knee joint is input to be -70 degrees, and the minimum value thereof is input to be -100 degrees. Therefore, the output unit 63 refers to the reference DB 1e to extract causal relationship information indicating that height information indicates 155, and the maximum value and the minimum value of the variation range of the joint angle of the knee joint indicated by the variation range information are -70 degrees and -100 degrees, respectively.

However, as a practical matter, there will be no causal relationship information in which the maximum value of the variation range of the joint angle of the knee joint indicated by the variation range information is -70 degrees. This is because, even if the reference DB 1e has 21,600 kinds of causal relationship information, as long as the number is finite, it is extremely rare that the maximum value of the variation range of the joint angle of the knee joint matches a specified maximum value. Therefore, in the present embodiment, the output unit 63 refers to the reference DB 1e to extract causal relationship information in which height information is 155, and the maximum value and the minimum value of the variation range of the joint angle of the knee joint indicated by the variation range information are -70 degrees ±5 degrees and -100 degrees ± 5 degrees, respectively. By identifying the maximum value and the minimum value to be searched in a range instead of a point in this way, it is possible to restrain the situation where the corresponding causal relationship information does not exist.

Instead of the above, the extraction unit 62 may refers to the reference DB 1e to extract causal relationship information in which the height information is 155 and the maximum value and the minimum value of the variation range of the joint angle of the knee joint indicated by the variation range information are -70 degrees ± 3 degrees and -100 degrees ±5 degrees, respectively, and to extract the causal relationship information in which the maximum value and the minimum value of the variation range of the joint angle of the knee joint indicated by the variation range information are 70 degrees ±5 degrees and -100 degrees ±3 degrees, respectively. The same applies to height information.

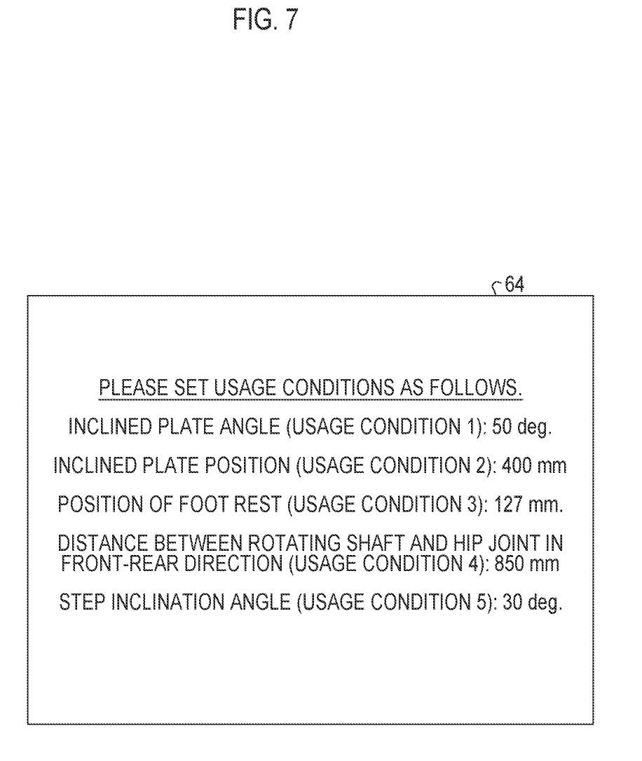

The output unit 63 outputs the usage condition information in the causal relationship information extracted by the extraction unit 62 to the display screen 64 of the touch panel display 1d as shown in FIG. 7. When the extraction unit 62 extracts a plurality of pieces of causal relationship information, the output unit 63 outputs, on the display screen 64 of the touch panel display 1d, the usage condition information in the causal relationship information selected according to a predetermined rule, among the pieces of causal relationship information extracted by the extraction unit 62. Here, the “predetermined rule” is typically a rule according to which the extraction unit 62 selects the causal relationship information extracted first on the time axis. In addition, as another example, the “predetermined rule” may be a rule according to which the causal relation information having the smallest difference between the maximum value of the variation range and the maximum value of the specified variation range are selected.

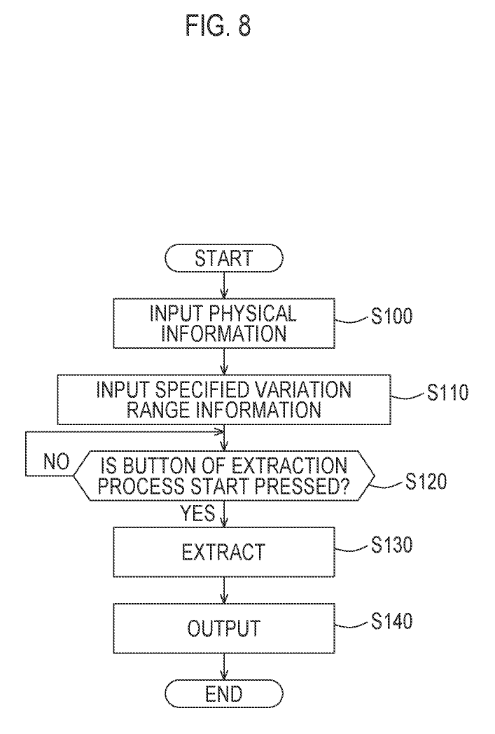

Next, the operation of the usage condition proposal device 1 will be described with reference to FIG. 8. The usage condition proposal device 1 is typically implemented by one personal computer. However, the usage condition proposal device 1 may be implemented by distributed processing by a plurality of personal computers configured to enable bidirectional communication.

Step S100: First, the physical information input unit 60 receives the input of the physical information for the user U.

Step S110: Next, the specified variation range information input unit 61 receives the input of the specified variation range information.

Step S120 and Step S130: When the button of the extraction process start 66 is pressed (Yes in step S120), the extraction unit 62 refers to the reference DB 1e to extract the causal relationship information of which the variation range information matches the specified variation range information.

Step S140: The output unit 63 outputs the usage condition information in the causal relationship information extracted by the extraction unit 62 to the display screen 64 of the touch panel display 1d.

Although the preferred embodiment of the present disclosure has been described above, the above-described embodiment has the following features.

The usage condition proposal device 1 (usage condition proposal system) includes the reference DB 1e having a plurality of pieces of causal relationship information that includes training information including the physical information for the user U and usage condition information for the foot pedaling exercise machine 100 (training machine), and variation range information that indicates a variation range of a joint angle of at least one joint of the user U when the user U performs the foot pedaling exercise (training) using the foot pedaling exercise machine 100 based on the usage condition information. The usage condition proposal device 1 includes the physical information input unit 60 that receives an input of the physical information for the user U, the specified variation range information input unit 61 that receives an input of specified variation range information indicating a specified variation range that is a variation range specified for the joint angle of the at least one joint of the user U, the extraction unit 62 that extracts, with reference to the reference DB 1e, the causal relationship information such that the variation range indicated by the variation range information satisfies a predetermined relationship with the specified variation range based on the physical information and the specified variation range information, and the output unit 63 that outputs the usage condition information in the causal relationship information extracted by the extraction unit 62. According to the above configuration, it is possible to set the variation range of the joint angle of at least one joint as desired when the foot pedaling exercise machine 100 is used for the foot pedaling exercise.

The extraction unit 62 refers to the reference DB 1e to extract causal relationship information in which the variation range indicated by the variation range information satisfies a predetermined relationship with the specified variation range out of the causal relationship information that has the same and closet physical information as input physical information, based on the input physical information and the specified variation range information.

The above-mentioned predetermined relationship is a relationship in which the variation range indicated by the variation range information matches the specified variation range. According to the above configuration, it is possible to do the foot pedaling exercise by using foot pedaling exercise machine 100 with the specified variation range.

The predetermined relationship is a relationship in which a difference between the maximum value of the variation range indicated by the variation range information and the maximum value of the specified variation range is less than or equal to a first threshold, or a relationship in which a difference between the minimum value of the variation range indicated by the variation range information and the minimum value of the specified variation range is less than or equal to a second threshold. According to the above configuration, a perfect match between the variation range indicated by the variation range information and the specified variation range is not required, and thus it is possible to restrain a situation in which the extraction unit 62 cannot extract causal relationship information satisfying conditions.

The first threshold and the second threshold are equal to each other. However, the first threshold and the second threshold may be different from each other.

The present disclosure is not limited to the above embodiment, and can be appropriately modified without departing from the spirit.

In the above example, the program can be stored and supplied to the computer by using various types of non-transitory computer readable media. The non-transitory computer readable media include various types of tangible storage media. Examples of non-transitory computer readable media include magnetic recording media (e.g., flexible disks, magnetic tapes, hard disk drives) and magneto-optical recording media (e.g., magneto-optical disks). Examples of non-transitory computer readable media further include compact disc (CD)-read only memories (ROMs), CD-recordable (R), CD-rewritable (R/W), semiconductor memories (e.g., mask ROMs). Examples of non-transitory computer readable media further include programmable ROM (PROM), erasable PROM (EPROM), flash ROM, random access memory (RAM). The program may also be supplied to the computer by various types of transitory computer readable media. Examples of the transitory computer readable media include electrical signals, optical signals, and electromagnetic waves. The transitory computer readable medium can supply the program to the computer via a wired communication path such as an electric wire and an optical fiber, or a wireless communication path.

A first aspect of the present disclosure relates to a usage condition proposal system. The usage condition proposal system includes a storage medium and a processor. The storage medium stores a reference database (DB) having a plurality of pieces of causal relationship information that includes training information and variation range information. The training information includes physical information for a user and usage condition information for a training machine, and the variation range information indicates a variation range of a joint angle of at least one joint of the user when the user trains using the training machine based on the usage condition information. The processor is configured to receive an input of the physical information for the user, receive an input of specified variation range information indicating a specified variation range that is a variation range specified for the joint angle of the at least one joint of the user, extract, with reference to the reference DB, based on the physical information and the specified variation range information, the causal relationship information of which the variation range information indicates the variation range satisfying a predetermined relationship with the specified variation range, and output the usage condition information in the extracted causal relationship information. According to the aspect, it is possible to set the variation range of the joint angle as desired when the training machine is used for training.

In the aspect, the predetermined relationship may be a relationship in which the variation range indicated by the variation range information matches the specified variation range.

In the aspect, the predetermined relationship may be a relationship in which a difference between the maximum value of the variation range indicated by the variation range information and the maximum value of the specified variation range is less than or equal to a first threshold, or a relationship in which a difference between the minimum value of the variation range indicated by the variation range information and the minimum value of the specified variation range is less than or equal to a second threshold.

In the aspect, the first threshold and the second threshold may be equal to each other.

In the aspect, the physical information may be at least information indicating height.

In the aspect, the usage condition information may indicate a plurality of usage conditions that is adjustable when the training machine is used.

In the aspect, the usage condition information may indicate a static usage condition.

In the aspect, the training machine may be a foot pedaling exercise machine with which the user performs a foot pedaling exercise in a sitting position.

In the aspect, the at least one joint may be at least one of a hip joint, a knee joint, and an ankle joint.

In the aspect, the pieces of causal relationship information may be different from each other in at least one of the physical information and the usage condition information.

A second aspect of the present disclosure relates to a usage condition proposal method that is executed by a CPU of a computer. The CPU of the computer is configured to refer to a reference DB having a plurality of pieces of causal relationship information that includes training information and variation range information. The training information includes physical information for a user and usage condition information for a training machine, and the variation range information indicates a variation range of a joint angle of at least one joint of the user when the user trains using the training machine based on the usage condition information. The usage condition proposal method includes receiving an input of the physical information for the user, receiving an input of specified variation range information indicating a specified variation range that is a variation range specified for the joint angle of the at least one joint of the user, extracting, with reference to the reference DB, based on the physical information and the specified variation range information, the causal relationship information of which the variation range information indicates the variation range satisfying a predetermined relationship with the specified variation range, and outputting the usage condition information in the extracted causal relationship information. According to the aspect, it is possible to set the variation range of the joint angle as desired when the training machine is used for training.

In the aspect, the predetermined relationship may be a relationship in which the variation range indicated by the variation range information matches the specified variation range.

In the aspect, the predetermined relationship may be a relationship in which a difference between the maximum value of the variation range indicated by the variation range information and the maximum value of the specified variation range is less than or equal to a first threshold, or a relationship in which a difference between the minimum value of the variation range indicated by the variation range information and the minimum value of the specified variation range is less than or equal to a second threshold.

In the aspect, the first threshold and the second threshold may be equal to each other.

In the aspect, the physical information may be at least information indicating height.

In the aspect, the usage condition information may indicate the plurality of usage conditions that is adjustable when the training machine is used.

In the aspect, the usage condition information may indicate a static usage condition.

In the aspect, the training machine may be a foot pedaling exercise machine with which the user performs a foot pedaling exercise in a sitting position.

In the aspect, the at least one joint may be at least one of a hip joint, a knee joint, and an ankle joint.

In the aspect, the pieces of causal relationship information may be different from each other in at least one of the physical information and the usage condition information.

Further, in the aspect, a non-transitory storage medium may store a program that is executed by a processor and that causes the processor to execute the usage condition proposal method described above.

What is claimed is:

1. A usage condition proposal system comprising:
a storage medium that stores a reference database (DB) having a plurality of pieces of causal relationship information that includes training information and variation range information, the training information including physical information for a user and usage condition information for a training machine, the variation range information indicating a variation range of a joint angle of at least one joint of the user when the user trains using the training machine based on the usage condition information; and
a processor configured to
receive an input of the physical information for the user,
receive an input of specified variation range information indicating a specified variation range that is a variation range specified for the joint angle of the at least one joint of the user,
extract, with reference to the reference DB, based on the physical information and the specified variation range information, the causal relationship information of which the variation range information indicates the variation range satisfying a predetermined relationship with the specified variation range, and
output the usage condition information in the extracted causal relationship information.

2. The usage condition proposal system according to claim 1, wherein the predetermined relationship is a relationship in which the variation range indicated by the variation range information matches the specified variation range.

3. The usage condition proposal system according to claim 1, wherein the predetermined relationship is a relationship in which a difference between a maximum value of the variation range indicated by the variation range information and a maximum value of the specified variation range is less than or equal to a first threshold, or a relationship in which a difference between a minimum value of the variation range indicated by the variation range information and a minimum value of the specified variation range is less than or equal to a second threshold.

4. The usage condition proposal system according to claim 3, wherein the first threshold and the second threshold are equal to each other.

5. The usage condition proposal system according to claim 1, wherein the physical information is at least information indicating height.

6. The usage condition proposal system according to claim 1, wherein the usage condition information indicates a plurality of usage conditions that is adjustable when the training machine is used.

7. The usage condition proposal system according to claim 1, wherein the usage condition information indicates a static usage condition.

8. The usage condition proposal system according to claim 1, wherein the training machine is a foot pedaling exercise machine with which the user performs a foot pedaling exercise in a sitting position.

9. The usage condition proposal system according to claim 1, wherein the at least one joint is at least one of a hip joint, a knee joint, and an ankle joint.

10. The usage condition proposal system according to claim 1, wherein the pieces of causal relationship information are different from each other in at least one of the physical information and the usage condition information.

11. A usage condition proposal method that is executed by a CPU of a computer, the CPU of the computer being configured to refer to a reference DB having a plurality of pieces of causal relationship information that includes training information and variation range information, the training information including physical information for a user and usage condition information for a training machine, and the variation range information indicating a variation range of a joint angle of at least one joint of the user when the user trains using the training machine based on the usage condition information, the usage condition proposal method comprising:
receiving an input of the physical information for the user;
receiving an input of specified variation range information indicating a specified variation range that is a variation range specified for the joint angle of the at least one joint of the user;
extracting, with reference to the reference DB, based on the physical information and the specified variation range information, the causal relationship information of which the variation range information indicates the variation range satisfying a predetermined relationship with the specified variation range; and
outputting the usage condition information in the extracted causal relationship information.

12. The usage condition proposal method according to claim 11, wherein the predetermined relationship is a relationship in which the variation range indicated by the variation range information matches the specified variation range.

13. The usage condition proposal method according to claim 11, wherein the predetermined relationship is a relationship in which a difference between a maximum value of the variation range indicated by the variation range information and a maximum value of the specified variation range is less than or equal to a first threshold, or a relationship in which a difference between a minimum value of the variation range indicated by the variation range information and a minimum value of the specified variation range is less than or equal to a second threshold.

14. The usage condition proposal method according to claim 13, wherein the first threshold and the second threshold are equal to each other.

15. The usage condition proposal method according to claim 11, wherein the physical information is at least information indicating height.

16. The usage condition proposal method according to claim 11, wherein the usage condition information indicates a plurality of usage conditions that is adjustable when the training machine is used.

17. The usage condition proposal method according to claim 11, wherein the usage condition information indicates a static usage condition.

18. The usage condition proposal method according to claim 11, wherein the training machine is a foot pedaling exercise machine with which the user performs a foot pedaling exercise in a sitting position.

19. The usage condition proposal method according to claim 11, wherein the at least one joint is at least one of a hip joint, a knee joint, and an ankle joint.

20. The usage condition proposal method according to claim 11, wherein the pieces of causal relationship information are different from each other in at least one of the physical information and the usage condition information.

21. A non-transitory storage medium storing a program that is executable by a processor and that causes the processor to execute the usage condition proposal method according to claim 11.
